(19) United States
(12) Patent Application Publication
(10) Pub. No.: US 2013/0016600 A1
(43) Pub. Date: Jan. 17, 2013

(54) NETWORK APPARATUS AND METHOD OF RETRANSMITTING FRAME USING THE SAME

(71) Applicants: Sung Ho HWANG, Suwon (KR); Joun Sup Park, Suwon (KR); Ki Hong Kim, Suwon (KR); Chul Gyun Park, Yongin (KR); Tae Won Song, Seoul (KR); Sang Heon Pack, Seoul (KR)

(72) Inventors: Sung Ho HWANG, Suwon (KR); Joun Sup Park, Suwon (KR); Ki Hong Kim, Suwon (KR); Chul Gyun Park, Yongin (KR); Tae Won Song, Seoul (KR); Sang Heon Pack, Seoul (KR)

(73) Assignee: SAMSUNG ELECTRO-MECHANICS CO., LTD./ Korea University Research & Business Foundation

(21) Appl. No.: 13/288,760

(22) Filed: Nov. 3, 2011

(30) Foreign Application Priority Data
Jul. 11, 2011 (KR) 10-2011-0068303

(51) Int. Cl. H04L 12/26

(52) U.S. Cl. 370/216

(57) ABSTRACT

There is provided a network apparatus capable of effectively retransmitting a frame in a frame aggregation environment, and a method of retransmitting a frame using the same. The network apparatus includes: a transmitting node broadcasting a plurality of data frames in a frame aggregation environment; a receiving node receiving the plurality of broadcast data frames and broadcasting a reception result; and at least one relay node receiving and storing at least a portion of the plurality of broadcast data frames and transmitting, together with the transmitting node, a data frame for which retransmission is required to the receiving node according to a calculated transmission success rate when the reception result from the receiving node is a retransmission request.

### CROSS-REFERENCE TO RELATED APPLICATIONS

This application claims the priority of Korean Patent Application No. 10-2011-0068303 filed on Jul. 11, 2011, in the Korean Intellectual Property Office, the disclosure of which is incorporated herein by reference.

### BACKGROUND OF THE INVENTION

1. Field of the Invention

The present invention relates to a network apparatus capable of effectively retransmitting a frame in a frame aggregation environment, and a method of retransmitting a frame using the same.

2. Description of the Related Art

In the case of a wireless local area network (LAN) apparatus, in order to reliably transmit a frame between communication objects, when a receiving side receives a data frame, the receiving side transmits, to a transmitting side, the fact that it has successfully received the data frame through a frame called ACK (acknowledge) in a medium access control (MAC) layer. When the transmitting side determines that the frame has not been successfully transmitted, it retransmits the same data frame.

Previous communications mediums have performed communication in a wired environment. In this case, the retransmission of data is entirely performed by a transmitting side. This because that the corresponding data is only possessed by the transmitting side.

However, IEEE 802.11n, a new wireless LAN standard published on November, 2009, supports a frame aggregation method in a MAC layer in order to improve throughput performance. The frame aggregation method defines two methods, that is, an aggregation of MAC transmitting node (S)ervice data unit (A-M transmitting node (S) DU transmitting node (S)) aggregating a plurality of MAC transmitting node (S)ervice data units (M transmitting node (S) DUs) and an aggregation of MAC protocol data unit (A-MPDU transmitting node (S)) aggregating a plurality of MPDUs.

A retransmission method in a wireless LAN was used in IEEE 802.11a/b/g, previous wireless standards. Therefore, a new frame retransmission method capable of being used in a frame aggregation environment has been demanded.

### SUMMARY OF THE INVENTION

An aspect of the present invention provides a network apparatus capable of retransmitting a frame in a frame aggregation environment, and a method of retransmitting a frame using the same.

According to an aspect of the present invention, there is provided a network apparatus including: a transmitting node broadcasting a plurality of data frames in a frame aggregation environment; a receiving node receiving the plurality of broadcast data frames and broadcasting a reception result; and at least one relay node receiving and storing at least a portion of the plurality of broadcast data frames and transmitting, together with the transmitting node, a data frame for which retransmission is required to the receiving node according to a calculated transmission success rate when the reception result from the receiving node is a retransmission request.

The at least one relay node may calculate a transmission success rate in the case of transmitting the received at least a portion of the plurality of broadcast data frames to the receiving node.

The at least one relay node may set a contention window value according to the calculated transmission success rate.

The at least one relay node may be provided in plural, and a relay node having the data frame for which retransmission is required, among the plurality of relay nodes, may preoccupy a channel according to the contention window value to thereby retransmit the required data frame to the receiving node.

Relay nodes among the plurality of relay nodes, colliding with each other at the time of the preoccupancy of the channel, may reset contention window values.

According to another aspect of the present invention, there is provided a method of retransmitting a frame using a network apparatus, the method including: broadcasting, by a transmitting node, a plurality of data frames in a frame aggregation environment; receiving, by a receiving node, the plurality of broadcast data frames and broadcasting a reception result; and receiving and storing, by at least one relay node, at least a portion of the plurality of broadcast data frames and transmitting, together with the transmitting node, a data frame for which retransmission is required to the receiving node according to a calculated transmission success rate when the reception result from the receiving node is a retransmission request.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration diagram of a network apparatus according to an embodiment of the present invention;

FIG. 2 is a configuration diagram showing a data transmission rate of a network apparatus according to an embodiment of the present invention; and

FIG. 3 is a timing diagram of a method of retransmitting a frame according to an embodiment of the present invention.

### DETAILED DESCRIPTION OF THE PREFERRED EMBODIMENT

Embodiments of the present invention will now be described in detail with reference to the accompanying drawings.

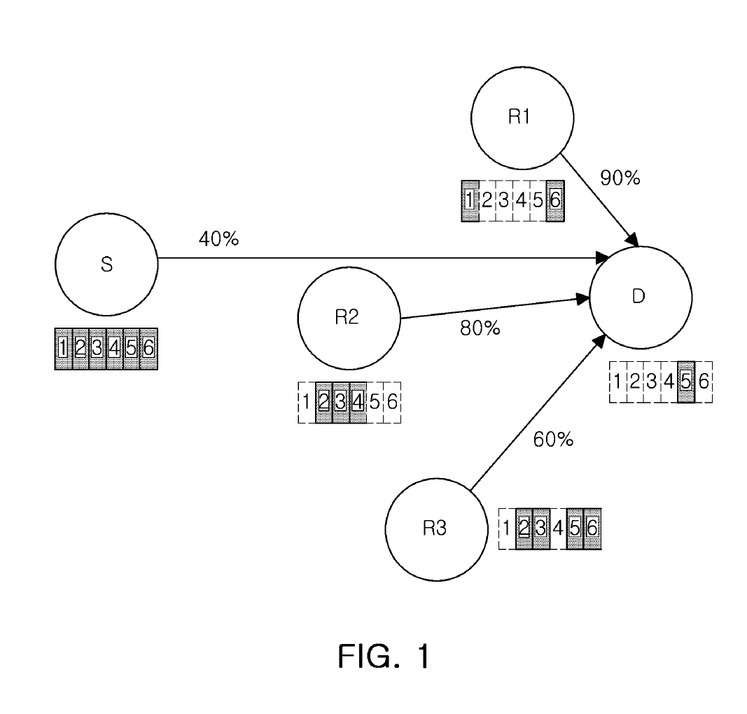

FIG. 1 is a schematic configuration diagram of a network apparatus according to an embodiment of the present invention.

Referring to FIG. 1, a network apparatus according to an embodiment of the present invention may include a transmitting node S, a receiving node D, and at least one relay node R1, R2, or R3. A plurality of the relay nodes R1, R2, and R3 may be provided. Although FIG. 1 shows three relay nodes, the present invention is not limited thereto. In addition, numerals represented in links shown in FIG. 1 indicate a transmission success rate.

The transmitting node S may aggregate and broadcast a plurality of data frames in a frame aggregation environment. For example, as shown, first to sixth data frames (reference numerals 1 to 6) may be aggregated and broadcast together.

Here, the relay nodes R1, R2, and R3 may receive and store at least a portion of the plurality of broadcast data frames.

The receiving node D may receive the plurality of broadcast data frames and broadcast a reception result according to whether all of the plurality of broadcast data frames have been received thereby or whether some of the plurality of broadcast data frames have not been received thereby. When the receiving node D has not received some of the plurality of broadcast data frames, the transmitting node S or one of the relay nodes R1, R2, and R3 may perform retransmission. In this case, the relay node R1 having the highest transmission success rate may perform retransmission.

An example of the same network on the assumption of the frame aggregation environment is shown in FIG. 1. Reference numerals 1 to 6 represent the respective aggregated subframes, and shadows represent received and possessed subframes. In this case, transmission of the subframe by the relay or the transmitting node having a high transmission success rate is not always preferable. Rather, transmission of the subframe by the relay or the transmitting node having a slightly low transmission success rate but having more subframes may be more advantageous. In the present invention, a method of selecting a more effective relay will be described below.

An operation process of the transmitting node S is the same as those of the relay nodes R1, R2, and R3 except for an operation to be described below conducted after transmission starts. A difference in an operation will be described below. First, it is determined whether a channel capable of transmitting a frame in which the plurality of data frames are aggregated is empty. When the channel is empty, the aggregated frame to be transmitted is transmitted through the channel.

Second, when an ACK frame indicating that all subframes have been received is received from the receiving node D, after a transmission process ends, the aggregated frame is deleted from a buffer.

Third, when an ACK frame indicating that at least one subframe has not been received is received from the receiving node D, a retransmission process may be performed. In addition, when a preset reception result waiting time elapses, the aggregated frame may be retransmitted.

The transmitting node S performs an appropriate operation according to the above-mentioned three situations. In the first situation, a series of transmission and reception processes successfully end. In the second situation, a retransmission process is performed. At this time, a distributed retransmission process may be performed together with the relay nodes R1, R2, and R3. This process will be described in detail below in an operation process of the relay node. In the third situation, the frame remaining in the buffer that has been transmitted is retransmitted. Then, the above-mentioned first to third processes are performed according to the result.

During the operation process S of the transmitting node S as described above, when the transmitting node enters the retransmission process, it may performs the same process as the processes performed by the relay nodes R1, R2, and R3.

First, all nodes ‘overhear’ surrounding channels in preparation for a situation in which they become the relay node. Here, ‘overhear’ means a case in which a node having an address different from an address set in a data frame receives the data frame. In this situation, when any transmitted data frame is received, the data frame is stored in the buffer, and a network allocation vector (NAV) value may be set. Virtual carrier sensing may be performed by using the value.

When the ACK frame broadcast from the receiving node D is received, whether or not retransmission needs be performed may be appreciated. When retransmission needs be performed, the relay nodes R1, R2, and R3 may appreciate which subframe may be used and which transmission mode is used and may perform a distributed retransmission process. When retransmission does not need to be performed, that is, when all subframes are successfully received, the overheard data frames are discarded.

The distributed retransmission is performed by each of the relay nodes R1, R2, and R3, together with the transmitting node which initially transmitted the data frame. The retransmission process is performed by a node first occupying a medium according to a series of processes, which may be represented by the following Equations.

$$\begin{matrix}E [ n ] = \frac{{k}_{n} * P}{{T}_{n}} & [ Equation 1 ] \\ E [ ideal ] = \frac{K * P}{{T}_{i}} & [ Equation 2 ]\end{matrix}$$

Where E[n] indicates an efficiency of each of relay candidate groups performing calculation, E[ideal] indicates a maximum value of the efficiency capable of being implemented. In addition, K indicates the number of maximum available subframes. In Equation 1, kₙ indicates the number of available subframes. For example, in FIG. 1, since the receiving node D has already received a fifth subframe, k₁ becomes 2, k₂ becomes 3, and k₃ becomes 3 except for the fifth subframe. The number of available subframes of the transmitting node S may be five except for the subframe denoted by reference numeral 5. P indicates a payload of each subframe. Tₙ indicates a time required for performing transmission from a corresponding relay node to the receiving node D. In Equation 2, Tᵢ indicates a transmission time required for a fastest transmission among possible transmission times. Through Equations given as described above, a transmission success rate of each rink, a transmission speed, and the number of available subframes in the frame aggregation environment may be used.

After the respective relay candidates distributedly calculate the respective efficiencies and the maximum efficiency without the aid of other nodes or a central processing unit as described above, they calculate α values from the following Equations 3 to 5.

$${α}_{n} = ⌈ \frac{E [ ideal ]}{E [ n ]} ⌉ \qquad [ Equation 3 ]$$

A probability that a node having high efficiency will first perform transmission is increased using the α value calculated by each node.

IFSₙ=αₙ*SIFS [Equation 4]

CWₙ=[0,αₙ*CWₘᵢₙ][Equation 5]

Where a short interframe space (SIFS) of each node is decreased or increased according to the α value, such that a time waiting for an empty channel changes and a contention window (CW) period also changes, whereby retransmission authority may be adjusted.

Meanwhile, a node receiving a frame in which the node's address is set as a destination becomes the receiving node D. The receiving node determines whether the respective subframes are satisfactorily received or errors are generated by checking the received frame, and broadcasts an ACK frame having a reception result according to the determination, as in the IEEE 802.11n standard.

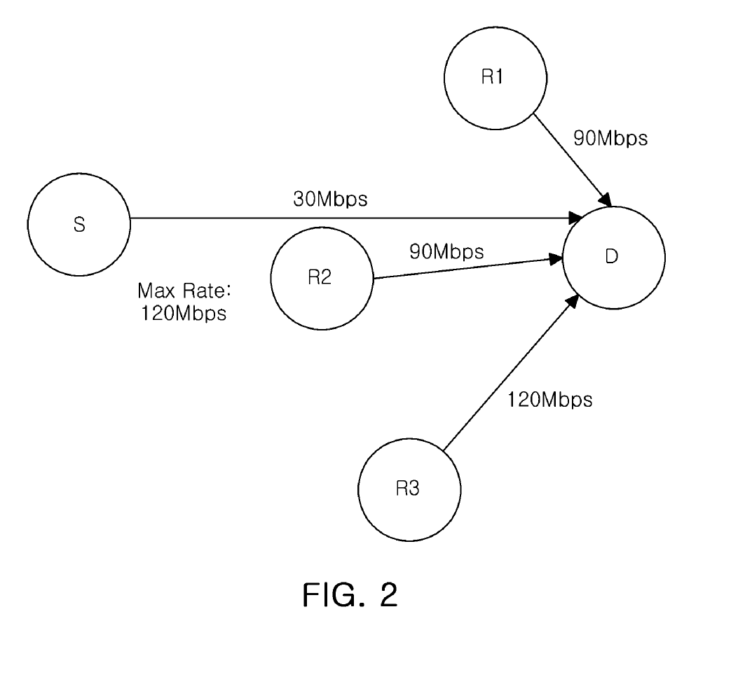

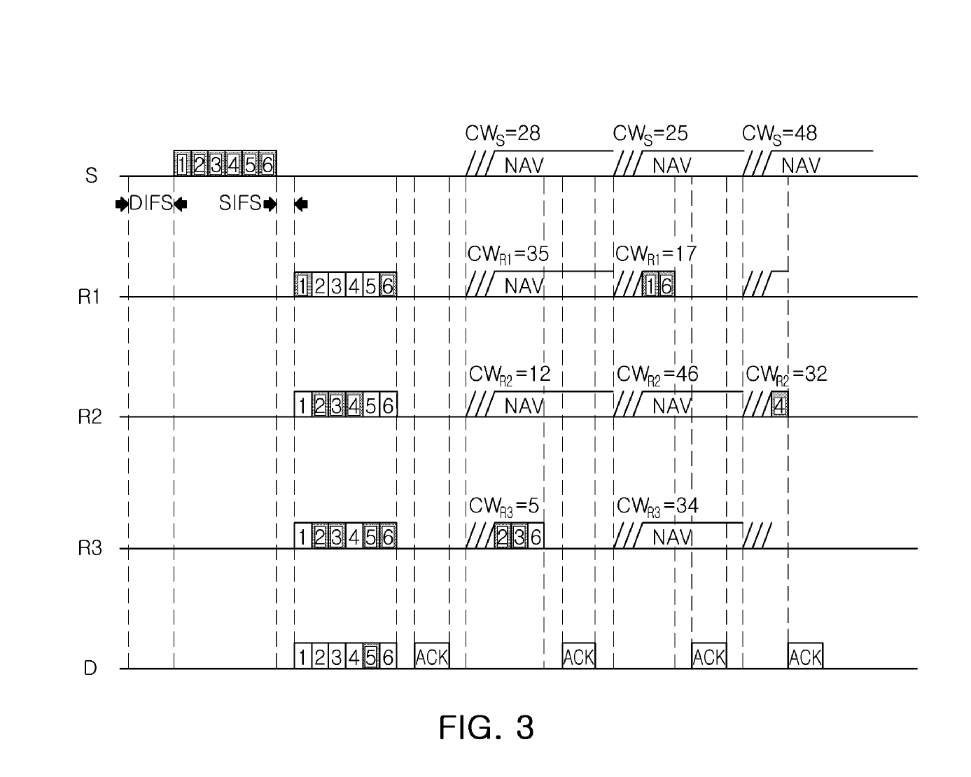

FIG. 2 is a configuration diagram showing a data transmission rate of a network apparatus according to an embodiment of the present invention; and FIG. 3 is a timing diagram of a method of retransmitting a frame according to an embodiment of the present invention.

Referring to FIGS. 2 and 3, a transmission speed of any link is determined as a fastest transmission speed in a range in which it does not exceed a defined error rate. The transmitting node S broadcasts a data frame to be transmitted to the receiving node D. As shown, a gray subframe indicates a data frame that is successfully received, and a dotted line transparent subframe indicates a data frame that is not successfully received. That is, the relay node (R1) has successfully received first and sixth subframes, the relay node R2 has successfully received second to fourth subframes, the relay node R3 has successfully received second, third, fifth, and sixth subframes, and the receiving node D has successfully received a fifth subframe. After a one-time transmission is performed, the transmitting node S and the relay nodes R1, R2, and R3 perform a retransmission process by preoccupying a channel in which a contention window (CW) expires. The α value may be calculated by the following Equation 6.

$${α}_{n} = ⌈ \frac{\frac{K * P}{{T}_{i}}}{\frac{{k}_{n} * P}{{T}_{n}}} ⌉ = ⌈ \frac{K * P * {R}_{i}}{{k}_{n} * P * {R}_{n}} ⌉ = ⌈ \frac{K * {R}_{i}}{{k}_{n} * {R}_{n}} ⌉ \qquad [ Equation 6 ]$$

Here, Rₙ indicates a transmission speed from a node n to a destination.

When α value of each node may be calculated according to Equation 6, it may be represented by the following Equation 7.

$${α}_{S} = ⌈ \frac{5 * 120}{5 * 30} ⌉ = 4 , \\ {α}_{R 1} = ⌈ \frac{5 * 120}{2 * 90} ⌉ = 4 , \\ {α}_{R 2} = ⌈ \frac{5 * 120}{3 * 90} ⌉ = 3 , \\ {α}_{R 3} = ⌈ \frac{5 * 120}{3 * 120} ⌉ = 2. \qquad [ Equation 7 ]$$

CWₘᵢₙ values are different according to a physical layer transmission scheme (in the case of IEEE 802.11, a frequency hopping spread spectrum, a direct sequence spread spectrum, and an infrared). However, in the present embodiment, it is assumed that the CWₘᵢₙ value is 15. Contention window (CW) values according to the α value are determined as follows.

CW_{S}=[0,4*CWₘᵢₙ]=[0,60],

CW_{R1}=[0,4*CWₘᵢₙ]=[0,60],

CW_{R2}=[0,3*CWₘᵢₙ]=[0,45],

CW_{R3}=[0,2*CWₘᵢₙ]=[0,30], [Equation 8]

According to the above Equation 8, when the relay node R3 has a smallest contention window value (CW_{R3}) and thus expires quickly as compared to other nodes, the other nodes delete the contention window value and set the NAV, such that they wait until the transmission ends. For example, in FIG. 2, the relay node R3 first occupies a channel to thereby perform retransmission, and other nodes waiting for expiration of the contention window value, that is, the transmitting node S and the relay nodes R1 and R2 recognize that the relay node R3 has performed retransmission, delete the contention window value, and again wait for an ACK frame from the receiving node D.

When a second ACK frame is transmitted and each node understands a transmission state and then recognizes that not all of subframes have been successfully transmitted, the above-mentioned process is repeated. The nodes receiving the second ACK frame may recognize that the sixth subframe has not been successfully received and the second, third, and fifth subframes have been successfully received to thereby understand available subframes. After second retransmission, distributedly calculated α values and CWₘᵢₙ values according to the α values are as follows.

$$\begin{matrix}{α}_{S} = ⌈ \frac{3 * 120}{3 * 30} ⌉ = 4 , \\ {α}_{R 1} = ⌈ \frac{3 * 120}{2 * 90} ⌉ = 2 , \\ {α}_{R 2} = ⌈ \frac{3 * 120}{1 * 90} ⌉ = 4 , \\ {α}_{R 3} = ⌈ \frac{3 * 120}{1 * 120} ⌉ = 3. & [ Equation 9 ] \\ {CW}_{S} = [ 0 , 4 * {CW}_{min} ] = [ 0 , 60 ] , \\ {CW}_{R 1} = [ 0 , 2 * {CW}_{min} ] = [ 0 , 30 ] , \\ {CW}_{R 2} = [ 0 , 4 * {CW}_{min} ] = [ 0 , 60 ] , \\ {CW}_{R 3} = [ 0 , 3 * {CW}_{min} ] = [ 0 , 45 ] . & [ Equation 10 ]\end{matrix}$$

Similar to the above Equations 7 and 8, contention window values are arbitrarily given in a period of [0, α*CWₘᵢₙ] and retransmission starts from a node in which the contention window value expires.

Here, the relay node R1 is selected and transmits the first and sixth subframes, which are available subframes. It may also be recognized through a third ACK frame that not all of subframes are transferred, and a further retransmission is prepared. All nodes may understand current states of the subframes currently successfully received by the receiving node D through the ACK frame. The receiving node D has receives the first, second, third, fifth, and six subframes, and an available subframe is a fourth subframe. Through this information, distributedly calculated α values and CWₘᵢₙ values according to the α values are as follows.

$$\begin{matrix}{α}_{S} = ⌈ \frac{1 * 120}{1 * 30} ⌉ = 4 , \\ {α}_{R 1} = ⌈ \frac{1 * 120}{0 * 90} ⌉ = ∞ , \\ {α}_{R 2} = ⌈ \frac{1 * 120}{1 * 90} ⌉ = 2 , \\ {α}_{R 3} = ⌈ \frac{1 * 120}{0 * 120} ⌉ = ∞ . & [ Equation 11 ] \\ {CW}_{S} = [ 0 , 4 * {CW}_{min} ] = [ 0 , 60 ] , \\ {CW}_{R 1} = [ 0 , 2 * {CW}_{min} ] = [ 0 , 30 ] , & [ Equation 12 ]\end{matrix}$$

Here, the nodes that do not have the available subframe at all may not participate in a retransmission process and wait until the retransmission process ends.

Meanwhile, the contention window values are set to be the same, such that collisions may be generated. In this case, the contention window values of the nodes causing the collision may be reset. For example, the contention window values of the nodes causing the collision may be set to be double, such that the nodes causing the collision waits for a doubled period of time. In addition, when other nodes first perform the retransmission process due to the expiration of the their contention window values or the nodes causing the collision perform the retransmission process due to expiration of contention window values thereof and one-time retransmission is thus completed, the contention window values contained by the nodes are deleted and a further retransmission is then prepared, as described above.

As set forth above, according to the embodiments of the present invention, when the receiving node requests retransmission of the data frame in the frame aggregation environment, retransmission of the data frame is distributedly performed, whereby retransmission may be efficiently performed. In addition, a separate control circuit is not required, whereby manufacturing costs may be reduced.

While the present invention has been shown and described in connection with the embodiments, it will be apparent to those skilled in the art that modifications and variations can be made without departing from the spirit and scope of the invention as defined by the appended claims.

What is claimed is:

1. A network apparatus comprising:
a transmitting node broadcasting a plurality of data frames in a frame aggregation environment;
a receiving node receiving the plurality of broadcast data frames and broadcasting a reception result; and
at least one relay node receiving and storing at least a portion of the plurality of broadcast data frames and transmitting, together with the transmitting node, a data frame for which retransmission is required to the receiving node according to a calculated transmission success rate when the reception result from the receiving node is a retransmission request.

2. The network apparatus of claim 1, wherein the at least one relay node calculates a transmission success rate in the case of transmitting the received at least a portion of the plurality of broadcast data frames to the receiving node.

3. The network apparatus of claim 2, wherein the at least one relay node sets a contention window value according to the calculated transmission success rate.

4. The network apparatus of claim 3, wherein the at least one relay node is provided in plural, and
a relay node having the data frame for which retransmission is required, among the plurality of relay nodes, preoccupies a channel according to the contention window value to thereby retransmit the required data frame to the receiving node.

5. The network apparatus of claim 4, wherein relay nodes among the plurality of relay nodes, colliding with each other at the time of the preoccupancy of the channel, reset contention window values.

6. A method of retransmitting a frame using a network apparatus, the method comprising:
broadcasting, by a transmitting node, a plurality of data frames in a frame aggregation environment;
receiving, by a receiving node, the plurality of broadcast data frames and broadcasting a reception result; and
receiving and storing, by at least one relay node, at least a portion of the plurality of broadcast data frames and transmitting, together with the transmitting node, a data frame for which retransmission is required to the receiving node according to a calculated transmission success rate when the reception result from the receiving node is a retransmission request.

7. The method of claim 6, wherein in the transmitting of the data frame to the receiving node, the at least one relay node calculates a transmission success rate in the case of transmitting the at least a portion of the plurality of broadcast data frames to the receiving node.

8. The method of claim 7, wherein in the transmitting of the data frames to the receiving node, the at least one relay node sets a contention window value according to the calculated transmission success rate.

9. The method of claim 8, wherein in the transmitting of the data frame to the receiving node, the at least one relay node is provided in plural, and a relay node having the data frame for which retransmission is required, among the plurality of relay nodes, preoccupies a channel according to the contention window value to thereby retransmit the required data frame to the receiving node.

10. The method of claim 9, wherein in the transmitting of the data frame to the receiving node, relay nodes among the plurality of relay nodes, colliding with each other at the time of the preoccupancy of the channel, reset contention window values.
